(19) United States
(12) Patent Application Publication
(10) Pub. No.: US 2003/0031390 A1
(43) Pub. Date: Feb. 13, 2003

(54) Bearings

(76) Inventors: Colin W. Ericksen, Ellensburg, WA (US); Jeff S. Asher, Ellensburg, WA (US)

Correspondence Address: WOMBLE CARLYLE SANDRIDGE & RICE PLLC, 300 N. GREENE STREET, SUITE 1900, GREENSBORO, NC, 27401, US

(21) Appl. No.: 10/272,880

(22) Filed: Oct. 17, 2002

Related U.S. Application Data
(62) Division of application No. 09/531,976, filed on Mar. 20, 2000.

(51) Int. Cl. F16C 33/02; F16C 35/00; F16C 43/04

(52) U.S. Cl. 384/428; 384/296; 384/585

(57) ABSTRACT

The present invention is an improvement to bearings and is more particularly concerned with the aspect of changing the outer peripheral area of the bearing to a geometric shape other than circular.

### RELATED APPLICATIONS

This application is a divisional of application Ser. No. 09/531,976 filed Mar. 20, 2000.

### FIELD OF THE INVENTION

This invention relates to the general use of bearings in manufactured products.

### DISCUSSION OF PRIOR ART

Bearings are used extensively to produce consumer products, including but not limited to small tools and appliances. With regard to these consumer products, such as drills, mixers and blenders, the shafts of the electric motors that power these devices rotate in a bearing. The outer portion of the bearing is prevented from rotating with the shaft of the motor by being pressed into a housing of some type. This is known as an interference fit. If the device should need to have the bearings replaced, the device would have to be taken to a repair shop to have the old bearings pressed out and the new bearings pressed into the housing. In many cases involving small devices such as drills, blenders, etc., the cost of repair is greater than the purchase price of a replacement.

The only other alternative to the use of the interference fit is to use a bearing that has been pressed into a housing that is provided with flanges with attachment holes. This method is not cost-effective and is not used by the industry for that reason.

### SUMMARY OF THE INVENTION

Accordingly, it is an object of the invention to change the outer peripheral area of a bearing by changing the beating's outer geometric shape to a shape other than circular. By creating a housing in a device of the same shape and size to receive the bearing, the outer portion of the bearing is prevented from rotating. It is a further object of the invention that the bearing can thus be retained in the housing by simple means such as a clip or machine screw, making it possible for an average consumer to replace the bearing with ordinary hand tools.

It is a still further object of the invention, that a standard bearing having a circular external geometric shape can be modified by attaching material to the bearing, thus encasing the outer peripheral area to achieve a shape other than circular. This then would make the use of the present invention economical.

A further object of the invention is that the attaching of material to a standard bearing could be accomplished by several methods, including, but not limited to, injection molding, resin casting or a use of a machined or powder metal formed housing, having a outer geometric shape other than circular and a central hole to receive a standard bearing. This would allow the present invention to be usable in a wide variety of applications.

A still further object of the invention is that the changing of the outer geometric shape of a bearing is applicable to both ball and roller style bearings, but also can be applied to the manufacture of bronze, Teflon or other bearing materials.

### BRIEF DESCRIPTION OF THE DRAWINGS

Embodiments of the invention are described by way of example with reference to the accompanying drawings in which:

FIG. 1 is a front view of a standard ball or roller type bearing.

FIG. 2 is a side view of a standard ball or roller type bearing.

FIG. 3 is a perspective view of a standard bronze or Teflon bearing.

FIG. 4 is a top view of a standard ball or roller bearing encased in material to alter the outer geometric shape.

FIG. 5 is a side view of a standard ball or roller bearing encased in material to alter the outer geometric shape.

FIG. 6 is a perspective view of a standard bronze or Teflon bearing formed to have an outer geometric shape other than circular.

### DETAILED DESCRIPTION OF THE INVENTION

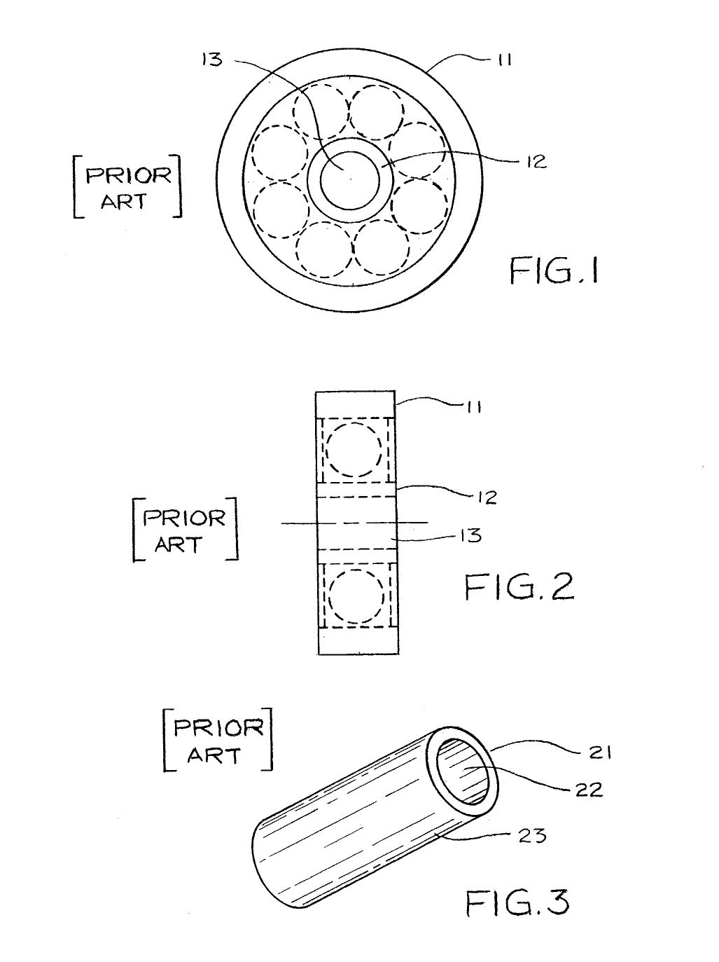

Referring to FIGS. 1 and 2, numeral 11 is a standard ball or roller bearing. Numeral 12 indicates the central hub of the inter race of a standard ball or roller bearing. Numeral 13 indicates a hole center to allow a shaft to pass through the bearing.

FIG. 3, numeral 21, is a standard bronze or Teflon bearing. Numeral 22 is the hole center to allow a shaft to pass through the bearing, and numeral 23 indicates the liner aspect of the bearing.

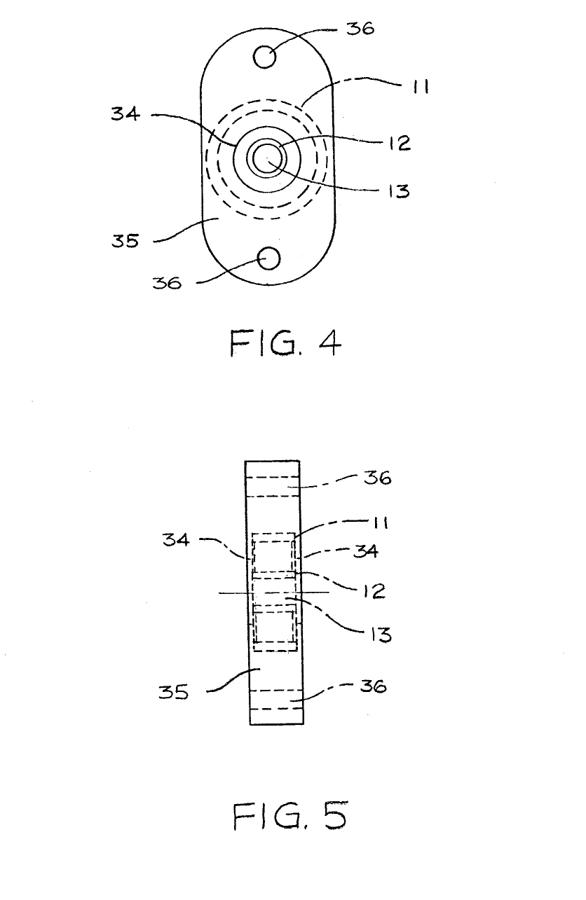

FIG. 4, numeral 11, is the standard ball or roller bearing after being encased in a material to alter the geometric shape of the bearing. Numeral 12 is the hub of the bearing, numeral 13 is the hole center and numeral 34 is the line of the material being sufficient distance from the hub of the numeral 12, so as not to restrict the free movement of hub 12. Numeral 35 is the added material having attachment hole 36 provided to anchor the bearing in a desired location.

FIG. 5, numeral 11, shows the bearing after being encased in the material. Numeral 12 indicates the hub of the bearing surrounding the hole center numeral 13. Numeral 34 references the edge of the material surrounding bearing 11, numeral 35 is added material and numeral 36, the attachment hole.

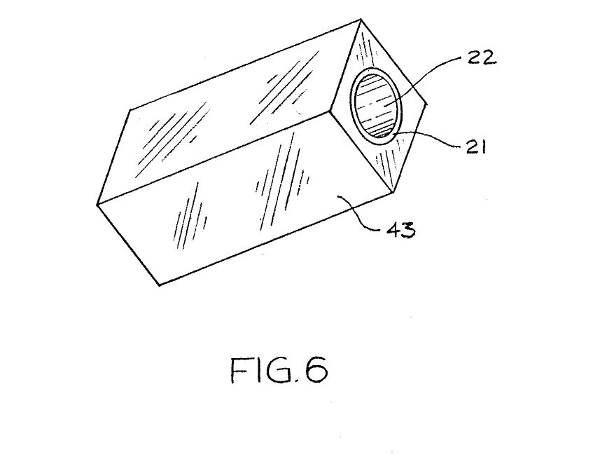

FIG. 6, numeral 21, is a bronze or Teflon bearing having the outer geometric shape altered. Numeral 22 is the hole to allow a shaft to pass through and numeral 43 indicates a liner dimension to the bearing.

What is claimed is:

1. A bearing assembly comprising:
(a) a bearing including a front face, a back face, a substantially circular outer periphery, a central opening, and a rotational axis;
(b) an outer casing having a substantially planar front face, a substantially planar back face, and an outer edge and being formed of a material that is moldable or castable onto the bearing, the outer edge having a non-circular outer shape that is bilaterally symmetrical about a plane that is perpendicular to the central rotational axis of the bearing parallel to said front and back faces;
(c) wherein the outer casing surrounds the entire outer periphery of the bearing and is securely engaged thereon; and
(d) wherein said outer casing has a substantially uniform thickness between said front face and said back face; and
(e) whereby the bearing assembly may be mounted with the front face facing forwardly or rearwardly.

2. A bearing assembly according to claim 1 wherein the outer casing is formed of plastic and is molded onto the outer periphery of the bearing.

3. A bearing assembly according to claim 1 wherein the outer casing is formed of resin and is cast onto the outer periphery of the bearing.

4. A bearing assembly according to claim 1 wherein the outer casing is formed of metal powder and is compacted onto the outer periphery of the bearing.

5. A bearing assembly according to claim 1 wherein the non-circular outer shape of the outer casing is substantially square or rectangular.

6. A bearing assembly according to claim 1 wherein the bearing comprises a ball bearing.

7. A bearing assembly according to claim 1 wherein the bearing comprises a roller bearing.

8. A bearing assembly according to claim 1 wherein the bearing comprises a cylindrical sleeve.

9. A bearing assembly according to claim 8 wherein the cylindrical sleeve is constructed of either bronze or a fluoropolymer.

10. A bearing assembly according to claim 1 wherein the bearing assembly is substantially bilaterally symmetrical about a plane that is perpendicular to the rotational axis of the bearing.

11. A bearing assembly comprising:
(a) a bearing including a substantially circular outer periphery, a central opening, and a central rotational axis; and
(b) a one-piece housing substantially surrounding the outer periphery of the bearing and being securely engaged thereon, the housing having a substantially planar front face, a substantially planar back face, and a non-circular outer shape having a substantially smooth outer contour, the outer shape of the housing having at least two-fold rotational symmetry about the central axis of the bearing, whereby the bearing assembly may be mounted in at least two positions, one angularly off-set from the other.

12. A bearing assembly according to claim 11 wherein the non-circular outer shape of the housing has at least four-fold rotational symmetry about the central axis of the bearing.

13. A bearing assembly according to claim 11 wherein the outer shape of the housing is a polygon.

14. A bearing assembly according to claim 11 wherein the outer shape of the housing is substantially square or substantially rectangular.

15. A bearing assembly according to claim 11 wherein the outer casing is formed of plastic and is molded onto the outer periphery of the bearing.

16. A bearing assembly according to claim 11 wherein the outer casing is formed of resin and is cast onto the outer periphery of the bearing.

17. A bearing assembly according to claim 11 wherein the outer casing is formed of metal powder compacted onto the outer periphery of the bearing.

18. A bearing assembly according to claim 11 wherein the bearing comprises a ball bearing.

19. A bearing assembly according to claim 11 wherein the bearing comprises a roller bearing.

20. A bearing assembly according to claim 11 wherein the bearing comprises a cylindrical sleeve.

21. A bearing assembly according to claim 20 wherein the cylindrical sleeve is constructed of either bronze or a fluoropolymer.

22. A bearing assembly according to claim 11 wherein the bearing assembly is substantially bilaterally symmetrical about a plane that is perpendicular to the central rotational axis of the bearing.

23. A bearing assembly comprising:
(a) a bearing including a substantially circular outer periphery, a central opening, and a central rotational axis; and
(b) a one-piece housing substantially surrounding the outer periphery of the bearing and being securely engaged thereon, the housing having a substantially planar front face, a substantially planar back face, and a non-circular outer shape having a substantially smooth outer contour, the outer shape of the housing having at least four-fold rotational symmetry about the central axis of the bearing whereby the bearing assembly may be mounted in at least four positions, each angularly off-set from the other;
wherein the bearing assembly is substantially bilaterally symmetrical about a plane that is perpendicular to the central rotational axis of the bearing wherein the bearing assembly may be mounted with the front face facing forwardly or rearwardly.
